(19) United States
(12) Patent Application Publication
(10) Pub. No.: US 2026/0139467 A1
(43) Pub. Date: May 21, 2026

(54) Underground Stormwater Management System

(71) Applicant: Pre-Con Products, Simi Valley, CA (US)

(72) Inventor: David Zarraonandia, Thousand Oaks, CA (US)

(21) Appl. No.: 18/949,649

(22) Filed: Nov. 15, 2024

(51) Int. Cl. E03F 5/16; B01D 17/04; B01D 29/07; B01D 29/13; B01D 29/52; B01D 39/14; C02F 1/00; C02F 101/32; C02F 103/00

(52) U.S. Cl. CPC E03F 5/16; B01D 17/045; B01D 29/07; B01D 29/13; B01D 29/52; B01D 39/14; C02F 1/004; B01D 2201/0415; B01D 2239/0618; C02F 2101/32; C02F 2103/001

(57) ABSTRACT

An underground stormwater management system comprising a first chamber, a second chamber, and at least one filter member. The first chamber has a floor, a plurality of walls, and an inlet. The second chamber has a floor and a plurality of walls. The filter member comprises a corrugated member and a filter fabric. The corrugated member has through holes that permit stormwater to flow through the corrugated member. The filter fabric covers at least a portion of the corrugated member and filters silt or particulate matter from stormwater before the stormwater flows through the through holes. At least one of the plurality of first chamber walls has a plurality of first openings that permit stormwater to flow from the first chamber to the second chamber. Stormwater flowing from the first chamber to the second chamber flows through the filter member before flowing through the plurality of first openings.

### CROSS-REFERENCE TO RELATED APPLICATIONS

Not Applicable.

### STATEMENT REGARDING FEDERALLY SPONSORED RESEARCH OR DEVELOPMENT

Not Applicable.

### APPENDIX

Not Applicable.

### BACKGROUND OF THE INVENTION

### Field of the Invention

This invention pertains to an underground stormwater management system.

### SUMMARY

One aspect of the disclosure is an underground stormwater management system comprising a first chamber, a second chamber, and at least one filter member. The first chamber has a first chamber floor, a plurality of first chamber walls, and an inlet. The inlet is adapted and configured to permit stormwater to flow from outside the stormwater management system into the first chamber. The second chamber has a second chamber floor and a plurality of second chamber walls. The at least one filter member comprises a corrugated member and a filter fabric. The corrugated member has a plurality of through holes adapted and configured to permit stormwater to flow through the corrugated member. The filter fabric covers at least a portion of the corrugated member and is adapted and configured to filter silt or particulate matter from stormwater before the stormwater flows through the plurality of through holes. At least one of the plurality of first chamber walls constitutes one of the plurality of second chamber walls and has a plurality of first openings. The plurality of first openings are adapted and configured to permit stormwater to flow from the first chamber to the second chamber. The filter member is connected to the at least one of the plurality of first chamber walls such that stormwater flowing from the first chamber to the second chamber flows through the filter member before flowing through the plurality of first openings.

Another aspect of the disclosure is an underground stormwater management system comprising a first chamber, a second chamber, and at least one filter member. The first chamber has a first chamber floor, a plurality of first chamber walls, and an inlet. The inlet is adapted and configured to permit stormwater to flow from outside the stormwater management system into the first chamber. The second chamber has a second chamber floor and a plurality of second chamber walls. The at least one filter member comprises a corrugated member and a filter fabric. The corrugated member has a plurality of through holes adapted and configured to permit stormwater to flow through the corrugated member. The filter fabric covers at least a portion of the corrugated member and is adapted and configured to filter silt or particular matter from stormwater before the stormwater flows through the plurality of through holes. At least one of the plurality of first chamber walls constitutes one of the plurality of second chamber walls and has a plurality of first openings. The plurality of first openings are adapted and configured to permit stormwater to flow from the first chamber to the second chamber. The filter member is connected to the at least one of the plurality of first chamber walls such that stormwater flowing from the first chamber to the second chamber flows through the filter member before flowing through the plurality of first openings. The filter member is removably connected to the at least one of the plurality of first chamber walls.

Further features and advantages, as well as the operation, are described in detail below with reference to the accompanying drawings.

### BRIEF DESCRIPTION OF THE DRAWINGS

FIG. 1 is a perspective view of an underground stormwater management system.

FIG. 2 is a perspective view of the walls and filter members of the underground stormwater management system of FIG. 1.

FIG. 3 is a cross-sectional view of the underground stormwater management system of FIG. 1 showing the interlock.

FIG. 4 is another perspective view of the underground stormwater management system of FIG. 1.

FIG. 5 is a perspective view of a filter member of the underground stormwater management system of FIG. 1.

FIG. 6 is a perspective view of a filter member of the underground stormwater management system of FIG. 1 with the filter fabric removed.

FIG. 7 is a magnified view of a portion of the filter member of FIG. 6.

FIG. 8 is a magnified view of a portion of the filter member of FIG. 6.

FIG. 9 is a perspective view of a locking bar of the underground stormwater management system of FIG. 1.

Reference numerals in the written specification and in the figures indicate corresponding items.

### DETAILED DESCRIPTION

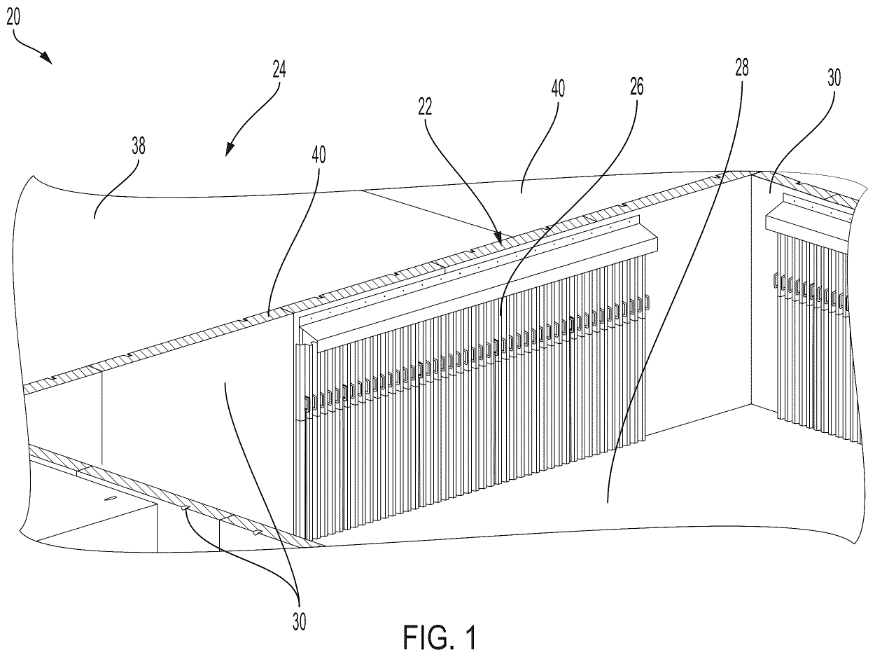

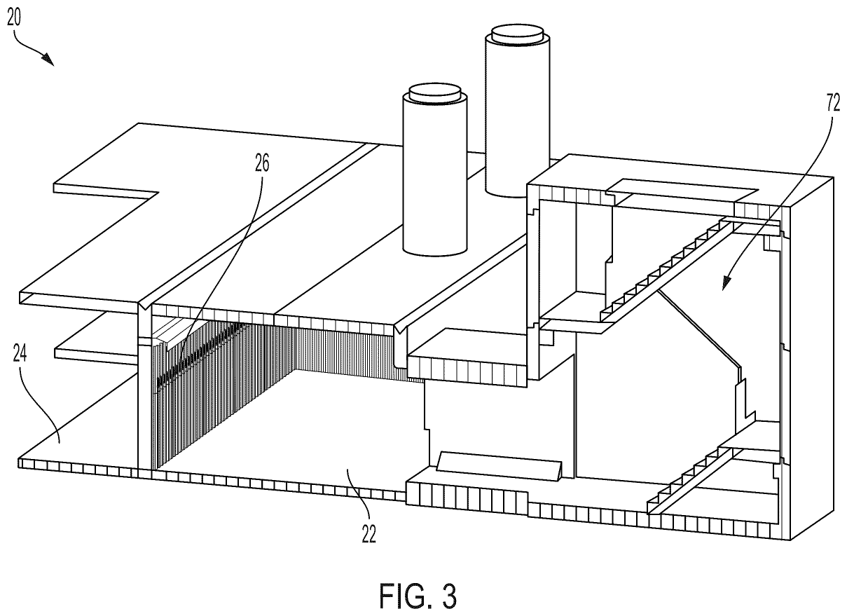

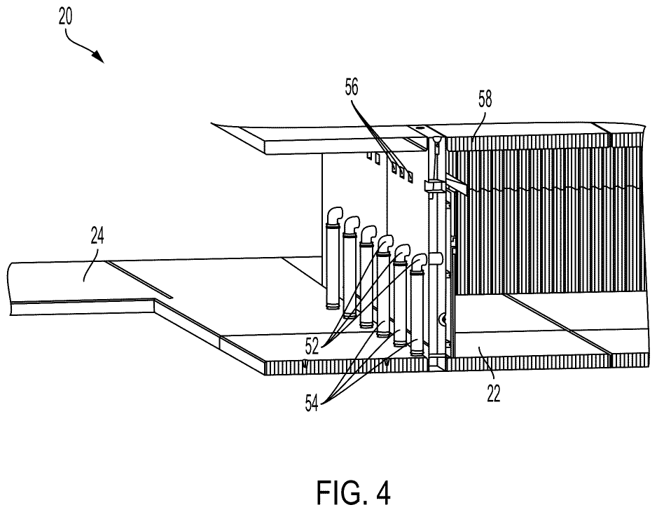

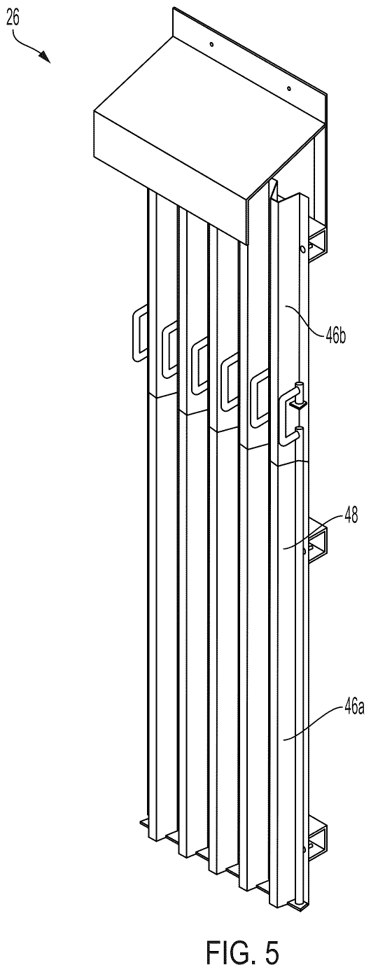

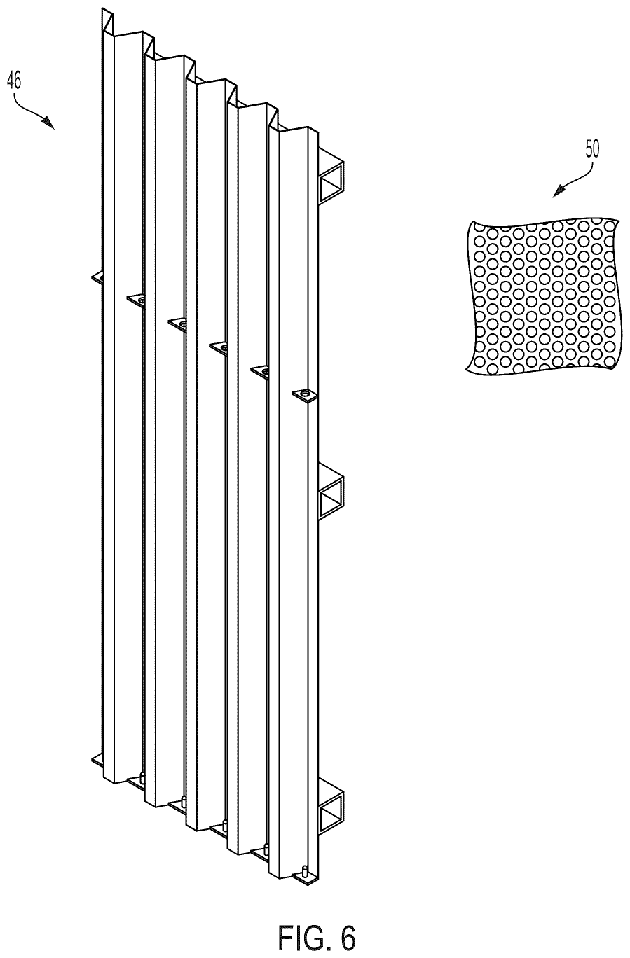

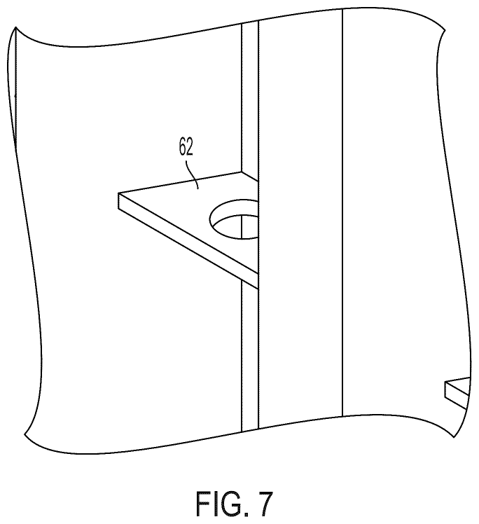

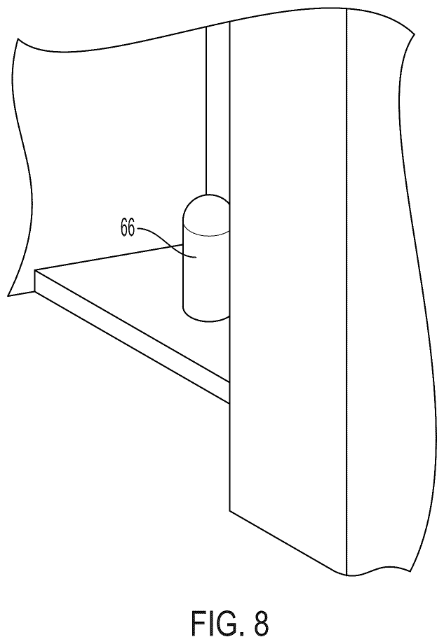

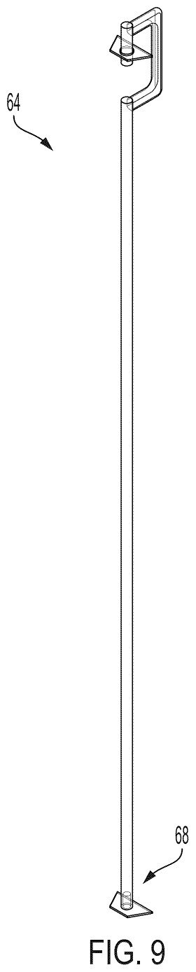

An embodiment of an underground stormwater management system in accordance with the present invention is generally indicated by reference number 20 in FIGS. 1-9. The underground stormwater management system 20 comprises a first chamber 22, a second chamber 24, and at least one filter member 26.

The first chamber 22 has a first chamber floor 28, a plurality of first chamber walls 30, and an inlet (not shown). The inlet is adapted and configured to permit stormwater to flow from outside the stormwater management system into the first chamber 22.

The first chamber floor 28 may comprise a plurality of first drainage openings (not shown). The plurality of first drainage openings are adapted and configured to permit stormwater in the first chamber 22 to flow through the plurality of first drainage openings and outside of the stormwater management system. Each of the plurality of first drainage openings may comprise a drain filter (not shown). Each of the drain filters may be adapted and configured to filter silt or particular matter from stormwater before the stormwater flows through the respective drainage opening.

The second chamber 24 has a second chamber floor 38 and a plurality of second chamber walls 40.

The second chamber floor 38 may further comprise a plurality of second drainage openings (not shown). The plurality of second drainage openings may be adapted and configured to permit stormwater in the second chamber 24 to flow through the plurality of second drainage openings and outside of the stormwater management system. Each of the plurality of second drainage openings may comprise a drain filter (not shown). Each of the drain filters may be adapted and configured to filter silt or particular matter from stormwater before the stormwater flows through the respective drainage opening.

The at least one filter member 26 comprises a corrugated member 46 and a filter fabric 48. The corrugated member 46 has a plurality of through holes 50. The plurality of through holes 50 are adapted and configured to permit stormwater to flow through the corrugated member 46. The filter fabric 48 covers at least a portion of the corrugated member 46 and is adapted and configured to filter silt or particulate matter from stormwater before the stormwater flows through the plurality of through holes 50. The corrugated member 46 may comprise a lower portion 46a and an upper portion 46b. The lower portion 46a may constitute the portion of the corrugated member covered by the filter fabric 48. The filter fabric 48 may cover between 25% and 50% inclusive of the corrugated member 46. More preferably, the filter fabric 48 may cover between 33% and 50% inclusive of the corrugated member 46.

A majority of the plurality of through holes 50 may have a diameter D between 1/32 inches and ½ inches inclusive. More preferably, a majority of the plurality of through holes 50 have a diameter D between 1/16 inches and ¼ inches inclusive. Even more preferably, a majority of the plurality of through holes 50 have a diameter D of ⅜ inches. At least 25% of the corrugated member 46 may comprise the plurality of through holes 50. More preferably, between 33% and 80% inclusive of the corrugated member 46 comprises the plurality of through holes 50. Even more preferably, between 50% and 80% inclusive of the corrugated member 46 comprises the plurality of through holes 50.

At least one of the plurality of first chamber walls 30 constitutes one of the plurality of second chamber walls 40 and has a plurality of first openings 52. The plurality of first openings 52 are adapted and configured to permit stormwater to flow from the first chamber 22 to the second chamber 24. Each of the plurality of first openings 52 may comprise a tubular filter member 54. The tubular filter members 54 may extend from the respective first opening 52 into the second chamber 24. Each of the tubular filter members 54 may extend from the respective first opening 52 to the second chamber floor 38 adjacent the at least one of the plurality of first chamber walls 30. Each of the tubular filter members 54 may be adapted and configured to filter silt or particulate matter from stormwater flowing through the tubular filter member.

The at least one of the plurality of first walls 30 may further comprise a plurality of second openings 56. The plurality of second openings 56 may be adapted and configured to permit stormwater to flow from the first chamber 22 to the second chamber 24 without flowing through the filter member 26. The first chamber 22 may further comprise a first chamber ceiling 58, and the plurality of second openings 56 may be adjacent the first chamber ceiling.

The filter member 26 is connected to the at least one of the plurality of first chamber walls 30 such that stormwater flowing from the first chamber 22 to the second chamber 24 flows through the filter member before flowing through the plurality of first openings 52. The filter member 26 may be removably connected to the at least one of the plurality of first chamber walls 30.

The at least one of the plurality of first chamber walls 30 may further comprise a passageway 60. The passageway 60 has a height 60h and a width 60w. A portion of the corrugated member 46 covers a portion of the passageway 60. The portion of the corrugated member 46 that covers a portion of the passageway 60 may be the entire corrugated member. The portion of the passageway 60 that is covered by the portion of the corrugated member 46 has a planar passageway area. The planar passageway area is equal to the height 60h times the width 60w. The portion of the corrugated member 46 that covers the portion of the passageway 60 has a corrugated member surface area. The corrugated member surface area may be 1 to 2.5 times the planar passageway area. Preferably, the corrugated member surface area A_{CM} may be 1.25 to 2.5 times the planar passageway area. More preferably, the corrugated member surface area A_{CM} may be 1.5 to 2.5 times the planar passageway area.

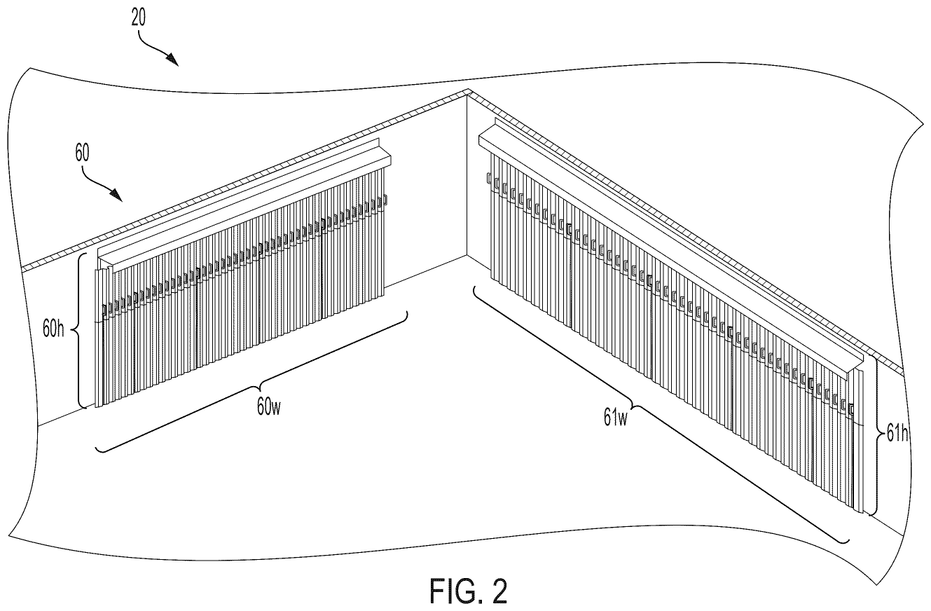

As shown in FIG. 2, the underground stormwater management system 20 may comprise more than one filter member 26. The wall to which the additional filter member is attached may further comprise a passageway 61. The passageway 61 has a height 61h and a width 61w, and the above disclosure applies equally herein, except that the planar passageway area of the passageway 61 is equal to the height 61h times the width 61w.

The corrugated member 46 may further comprise a plurality of slots 62. The filter member 26 may further comprise a plurality of locking bars 64. Each of the plurality of locking bars 64 may be adapted and configured to removably engage with one of the plurality of slots 62 to removably and operably connect the filter fabric 48 to the corrugated member 46. The first chamber floor 28 may comprise a plurality of pins 66 adjacent the at least one of the plurality of first chamber walls 30. Each of the plurality of locking bars 64 may comprise a hollow end 68 adapted and configured to overly and be releasably retained by one of the plurality of pins 66.

The filter fabric 48 and each of the drain filters may comprise a non-woven material. The tubular filter members 54 may also comprise a non-woven material. The non-woven material may be adapted and configured to filter oil-based fluids from the stormwater in the stormwater management system.

The underground stormwater management system 20 may further comprise an interlock 70. The interlock 70 may be adapted and configured to permit access to the first chamber 24 from outside the stormwater management system.

In view of the foregoing, it should be appreciated that the invention has several advantages over the prior art.

It should also be understood that when introducing elements of the present invention in the claims or in the above description of exemplary embodiments of the invention, the terms “comprising,” “including,” and “having” are intended to be open-ended and mean that there may be additional elements other than the listed elements. Additionally, the term “portion” should be construed as meaning some or all of the item or element that it qualifies. Moreover, use of identifiers such as first, second, and third should not be construed in a manner imposing any relative position or time sequence between limitations.

As various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. An underground stormwater management system comprising:
a first chamber having a first chamber floor, a plurality of first chamber walls, and an inlet adapted and configured to permit stormwater to flow from outside the stormwater management system into the first chamber;
a second chamber having a second chamber floor and a plurality of second chamber walls;
at least one filter member comprising a corrugated member and a filter fabric, the corrugated member having a plurality of through holes adapted and configured to permit stormwater to flow through the corrugated member, the filter fabric covering at least a portion of the corrugated member and being adapted and configured to filter silt or particulate matter from stormwater before the stormwater flows through the plurality of through holes;
wherein at least one of the plurality of first chamber walls constitutes one of the plurality of second chamber walls and has a plurality of first openings adapted and configured to permit stormwater to flow from the first chamber to the second chamber, the filter member being connected to the at least one of the plurality of first chamber walls such that stormwater flowing from the first chamber to the second chamber flows through the filter member before flowing through the plurality of first openings.

2. The underground stormwater management system of claim 1 wherein the at least one of the plurality of first chamber walls comprises a passageway, a portion of the corrugated member covering a portion of the passageway, the portion of the passageway covered by the portion of the corrugated member having a planar passageway area, the portion of the corrugated member covering the portion of the passageway having a corrugated member surface area, the corrugated member surface area being 1 to 2.5 times the planar passageway area.

3. The underground stormwater management system of claim 2 wherein the portion of the corrugated member comprises the entire corrugated member.

4. The underground stormwater management system of claim 2 wherein the corrugated member surface area is 125 to 2.5 times the planar passageway area.

5. The underground stormwater management system of claim 4 wherein the corrugated member surface area is 1.5 to 2.5 times the planar passageway area.

6. The underground stormwater management system of claim 2 wherein the filter member is removably connected to the at least one of the plurality of first chamber walls.

7. The underground stormwater management system of claim 6 wherein the corrugated member further comprises a plurality of slots and the filter member further comprises a plurality of locking bars, each of the plurality of locking bars being adapted and configured to removably engage with one of the plurality of slots to removably and operably connect the filter fabric to the corrugated member.

8. The underground stormwater management system of claim 7 wherein the first chamber floor comprises a plurality of pins adjacent the at least one of the plurality of walls, and wherein each of the plurality of locking bars comprises a hollow end adapted and configured to overly and be releasably retained by one of the plurality of pins.

9. The underground stormwater management system of claim 6 wherein the at least one of the plurality of first walls further comprises a plurality of second openings adapted and configured to permit stormwater to flow from the first chamber to the second chamber without flowing through the filter member.

10. The underground stormwater management system of claim 9 wherein the first chamber further comprises a first chamber ceiling, and wherein the plurality of second openings is adjacent the first chamber ceiling.

11. The underground stormwater management system of claim 9 further comprising an interlock, the interlock being adapted and configured to permit access to the first chamber from outside the stormwater management system.

12. The underground stormwater management system of claim 11 wherein the first chamber floor comprises a plurality of first drainage openings being adapted and configured to permit stormwater in the first chamber to flow through the plurality of first drainage openings and outside of the stormwater management system, and wherein the second chamber floor comprises a plurality of second drainage openings being adapted and configured to permit stormwater in the second chamber to flow through the plurality of second drainage openings and outside of the stormwater management system.

13. The underground stormwater management system of claim 12 wherein each of the plurality of first drainage openings comprise a drain filter and each of the plurality of second drainage openings comprise a drain filter, each of the drain filters being adapted and configured to filter silt or particular matter from stormwater before the stormwater flows through the drainage opening.

14. The underground stormwater management system of claim 12 wherein the filter fabric, each of the first floor filter members, and each of the second floor filter members comprises a non-woven material.

15. The underground stormwater management system of claim 13 wherein the non-woven material is adapted and configured to filter oil-based fluids from the stormwater in the stormwater management system.

16. An underground stormwater management system comprising:
a first chamber having a first chamber floor, a plurality of first chamber walls, and an inlet adapted and configured to permit stormwater to flow from outside the stormwater management system into the first chamber;
a second chamber having a second chamber floor and a plurality of second chamber walls;
at least one filter member comprising a corrugated member and a filter fabric, the corrugated member having a plurality of through holes adapted and configured to permit stormwater to flow through the corrugated member, the filter fabric covering at least a portion of the corrugated member and being adapted and configured to filter silt or particular matter from stormwater before the stormwater flows through the plurality of through holes;
wherein at least one of the plurality of first chamber walls constitutes one of the plurality of second chamber walls and has a plurality of first openings adapted and configured to permit stormwater to flow from the first chamber to the second chamber, the filter member being connected to the at least one of the plurality of first chamber walls such that stormwater flowing from the first chamber to the second chamber flows through the filter member before flowing through the plurality of first openings, and wherein the filter member is removably connected to the at least one of the plurality of first chamber walls.

17. The underground stormwater management system of claim 16 wherein the at least one of the plurality of first walls further comprises a plurality of second openings adapted and configured to permit stormwater to flow from the first chamber to the second chamber without flowing through the filter member.

18. The underground stormwater management system of claim 17 further comprising an interlock, the interlock being adapted and configured to permit access to the first chamber from outside the stormwater management system.

19. The underground stormwater management system of claim 17 wherein each of the plurality of first openings comprises a tubular filter member extending from respective first opening into the second chamber, each of the tubular filter members being adapted and configured to filter silt or particulate matter from stormwater flowing through the tubular filter member.

20. The underground stormwater management system of claim 19 wherein each of the tubular filter members extends from the respective first opening to the floor of the second chamber adjacent the at least one of the plurality of first chamber walls.

21. The underground stormwater management system of claim 19 wherein each of the tubular filter members comprises a non-woven material adapted and configured to filter oil-based fluids from the stormwater in the stormwater management system.

22. The underground stormwater management system of claim 16 wherein a majority of the plurality of through holes have a diameter between 1/32 inches and ½ inches inclusive.

23. The underground stormwater management system of claim 22 wherein a majority of the plurality of through holes have a diameter between 1/16 inches and ¼ inches inclusive.

24. The underground stormwater management system of claim 23 wherein a majority of the plurality of through holes have a diameter of ⅜ inches.

25. The underground stormwater management system of claim 16 wherein at least 25% of the corrugated member comprises the plurality of through holes.

26. The underground stormwater management system of claim 25 wherein between 33% and 80% inclusive of the corrugated member comprises the plurality of through holes.

27. The underground stormwater management system of claim 26 wherein between 50% and 80% inclusive of the corrugated member comprises the plurality of through holes.

28. The underground stormwater management system of claim 16 wherein the filter fabric covers between 25% and 50% inclusive of the corrugated member.

29. The underground stormwater management system of claim 28 wherein the corrugated member comprises a lower portion and an upper portion, and wherein the lower portion constitutes the portion of the corrugated member covered by the filter fabric.

30. The underground stormwater management system of claim 29 wherein the filter fabric covers between 33% and 50% inclusive of the corrugated member.
